(19) United States
(12) Patent Application Publication
(10) Pub. No.: US 2006/0251024 A1
(43) Pub. Date: Nov. 9, 2006

(54) Arrangements and method for power estimation

(76) Inventor: Hai Wang, Beijing (CN)

Correspondence Address: NIXON & VANDERHYE, PC, 901 NORTH GLEBE ROAD, 11TH FLOOR, ARLINGTON, VA, 22203, US

(21) Appl. No.: 10/546,154

(22) PCT Filed: Feb. 22, 2003
(86) PCT No.: PCT/CN03/00137

§ 371 Date: May 2, 2006

(51) Int. Cl. H04Q 7/00

(52) U.S. Cl. 370/333

(57) ABSTRACT

The present invention relates to an apparatus and method for estimating down link wide-band interference power and noise power in a mobile communications system. By using filters that are matched to the multipath channels of a number of base stations the received powers from the base stations may be differentiated and calculated. The impulse responses of the multipath channels are estimated and the filters are matched such that the impulse response of each filter is the complex conjugate of the time reverse of the estimated impulse response of one of the multipath channels. White noise is modelled as a signal that has passed a single-ray channel. The received noise power is estimated by means of the output signals from the matched filters and the total received signal.

### FIELD OF THE INVENTION

The present invention relates to communications systems and methods, and more particularly, to estimation of received signal power from a number of different base stations and from white noise.

### BACKGROUND OF THE INVENTION

In cellular communications systems a number of user terminals (typically mobile stations) are provided wireless access to a radio access network by communicating with a base station. Communication from the user terminal to the base station is known as uplink and communication from the base station to the user terminal is known as downlink.

A cellular mobile communication system is allocated a frequency spectrum for the radio communication between the user terminals and the base stations. When several user terminals require wireless services from the system simultaneously a technique for sharing the available spectrum between multiple users must be, used. There are several different types of multiple access techniques such as frequency division multiple access (FDMA), time division multiple access (TDMA) and code division multiple access (CDMA).

In CDMA systems spread spectrum techniques are used to define a channel by modulating a data-modulated carrier signal by a unique spreading code. A spreading code is a code that spreads an original data-modulated carrier over a wide portion of the allocated frequency spectrum. Each value of the spreading code is known as a chip and has a chip rate that is the same or faster than the data rate.

In mobile communication, multipath propagation is caused by reflections (echoes), which means that a transmitted signal reaches the receiver in different batches with different delay. Multipath propagation gives rise to unwanted interference noise that reduces the quality of the radio communication between the user terminal and the base station. Noise that reduces the quality of the radio communication is also caused by interference by other base stations and user terminals and by thermal noise.

In order to compensate for the negative effects of interference, several techniques for processing received spread spectrum signals that account for interference have been developed. With the development of such techniques a need to perform power estimation on the wide-band interference and white noise at a CDMA receiver has arisen.

The international patent application WO 01/01595 A1 discusses three different methods of estimating the power of interference and white noise at a downlink CDMA receiver. According to the first method a base station informs a mobile station of the power level of all the signals being transmitted from the base station. The mobile station is able to compute an estimate of its received power using conventional means and then use the base station information to determine an estimate of the relative received power of the interference. Using this estimate of the relative power of interference and the estimate of the total received power, obtained using conventional means, an estimate of the noise power (interference from other base stations than the serving base station and thermal noise) could be obtained.

According to a second method mentioned in the international patent application WO 01/01595 A1 the base station informs the mobile station of the active channelisation codes used in the cell. The mobile station is then able to compute an estimate of the received power of each active code channel using conventional means and add them together to determine an estimate of the received power of the interference. Using this estimate of the received power of interference and an estimate of the total received power, obtained using conventional means, an estimate of the noise power (interference from other base stations than the serving base station and thermal noise) could be obtained.

According to a third method mentioned in the international patent application WO 01/01595 A1 the mobile station blindly detects which code channels are active and which are not. The mobile station is then able to compute an estimate of the received power of each active code channel using conventional means and add them together to determine an estimate of the received power of the interference. Using this estimate of the received power of interference and an estimate of the total received power, obtained using conventional means, an estimate of the noise power (interference from other base stations than the serving base station and thermal noise) could be obtained.

There are a number of drawbacks associated with the three methods discussed above. The first two methods are not valid in reality, since the current WCDMA and CDMA2000 standards do not support the signalling required for these two methods. Furthermore it is very time-consuming to blindly detect the code usage status according to the third method, since all possible codes (e.g., 256 or 128) has to be examined. Moreover all of the three methods assume that only the base station that is serving the mobile station is very strong and that the signals from other base stations are quite weak and can be modelled as white noise. However, this assumption does not hold at the cell edge, i.e. at the handover region.

### SUMMARY OF THE INVENTION

An object of the present invention is to provide a method and apparatus for estimating the received powers from a number of base stations and according to an embodiment of the invention also the received power from white noise.

The above stated object is achieved by means of an apparatus according to claim 1, and by means of a method according to claim 12.

Embodiments of the present invention make use of filters that are matched to the multipath channels of a number of surrounding base stations in order to determine an estimate of the downlink interference power. The matched filters are used to differentiate the received powers from the different base stations.

White noise may be modelled as a signal that has passed a single-ray channel. According to the present invention the received noise power may be estimated from the output signals from the matched filters and the total received signal.

According to a first aspect, the present invention provides an apparatus for power estimation. The apparatus is arranged to estimate the powers of a set of signals received in a receiver. The set of signals are signals from a set of base stations. Each of the signals from the base stations has passed a multipath channel of an air interface. The apparatus comprises a set of filters each for filtering a received total signal. Each of the filters is matched to a normalized model of one of the multipath channels of a respective one of the base stations. The apparatus also comprises means for calculating an estimate of the received power from each base station in the set of base stations based on the output signals from the set of filters.

According to a second aspect, the present invention provides a method for estimating the powers of a set of signals received in a receiver. The set of signals are signals from a set of base stations. Each of the signals from the base stations has passed a multipath channel of an air interface. The method involves the step of filtering a received total signal through a set of parallel filters. Each of the filters is matched to a normalized model of one of the multipath channels of a respective one of the base stations. The method also involves the step of calculating an estimate of the received power from each of the set of base stations based on the output signals from the set of filters.

An advantage of the present invention is that unlike the prior art solutions discussed above it does not require any modifications of existing standards such as CDMA standards since the method and apparatus according to the present invention does not require any added signalling in order to produce the power estimates. Thus the present invention does not cause any added signalling burden in order to produce estimates of interference power and noise power.

Another advantage of the present invention is that it is not as time consuming as one of the prior art methods discussed above, since it does not require checking the status of a large number of channelisation codes.

A further advantage of the present invention is that it allows for good estimates of interference power even at the cell edge where the signals from several base stations may have relatively high and comparable strengths.

Further advantages and objects of embodiments of the present invention will become apparent when reading the following detailed description in conjunction with the drawings.

### BRIEF DESCRIPTION OF THE DRAWINGS

FIG. 1 is a schematic block diagram illustrating cells of a mobile access network, and mobile stations and base stations located therein.

FIG. 2 is a schematic block diagram illustrating a power estimator according to the present invention.

FIG. 3 is a schematic block diagram illustrating an application of the present invention for estimation of effective interference plus noise power.

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements.

According to the present invention a power estimator is provided for estimating received powers from surrounding base stations and white noise separately in a CDMA receiver.

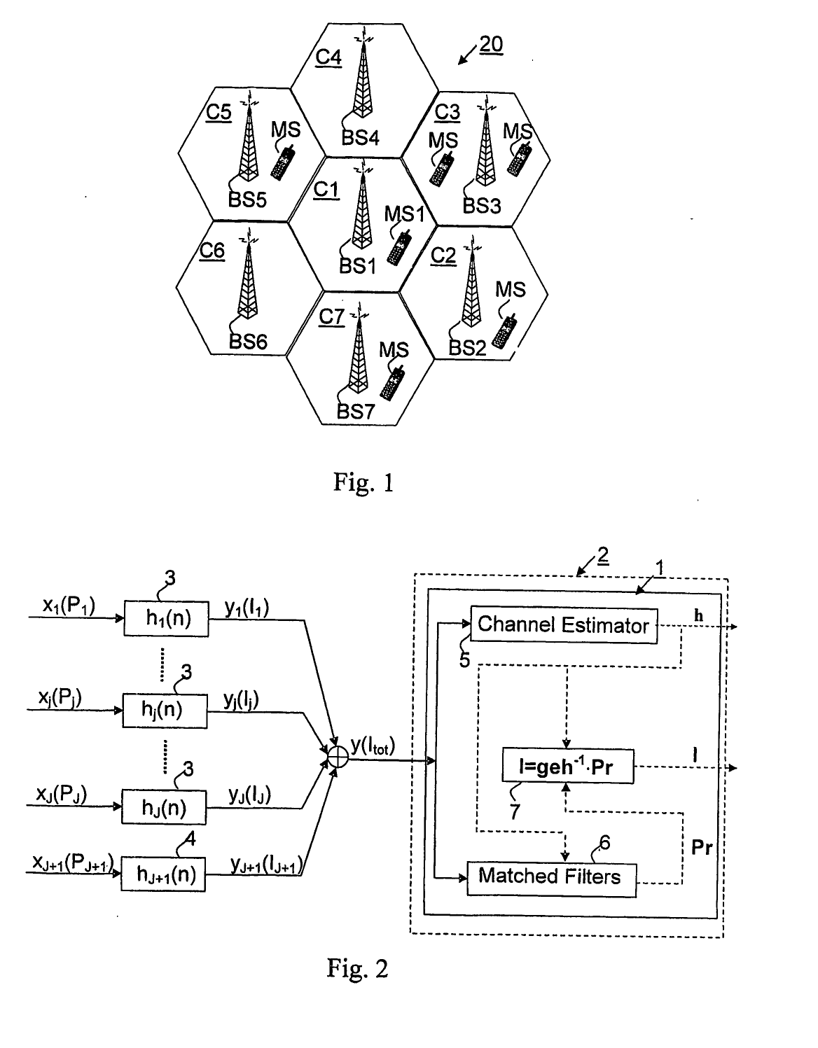

FIG. 1 is a schematic illustration of cells C1-C7 of a mobile access network 20 in a CDMA system. Each cell is served by a base station BS1-BS7. A mobile station MS1, which is located in the cell C1 is served by the base station BS1. The mobile station MS1 may however also be able to detect signals from other base stations such as base stations BS2, BS3 and BS7 which serve mobile stations MS located in the cells C2, C3 and C7 respectively. The signals from the other base stations contribute to the interference experienced by the mobile station MS1. The signals that the mobile station MS1 from the base stations will due to reflections comprise signal components that have travelled along different paths, i.e. the signals will have passed multipath channels. The present invention concerns apparatuses and methods for determining and differentiating the received signal powers from a number of base stations and white noise in a CDMA receiver. The CDMA receiver may be the receiver of the mobile station MS1, which may be of any type such as a mobile phone, a portable computer, a PDA etc.

In CDMA systems, the received signal from a transmitter is actually coloured since it has passed a multipath channel.

For the CDMA uplink, it can be assumed that the received total signal at the base station BS1-BS7 is a white one since it is composed of components from a lot of different mobile stations MS and the powers are roughly comparable to each other due to the effect of power control.

For the CDMA downlink, different assumptions can be made depending on the composition of the received total signal.

If the received total signal at the mobile station includes components from a lot of base stations and the powers of the different components are roughly comparable to each other, we can assume that the received total signal is a white one. However this assumption is not valid in a real cellular system.

If the received total signal at the mobile station is mainly from one base station, then the received total signal is obviously coloured. If the remaining part of the received total signal is from a lot of base stations and their powers are roughly comparable to each other, we can assume that the remaining part of the signal is a white one. This latter situation corresponds to the situation where the mobile station is located close to the centre of a cell.

If the received total signal at the mobile station is mainly from a few base stations and their powers are roughly comparable to each other, then the received total signal is obviously coloured. If the remaining part of the received total signal is from a lot of base stations and their powers are roughly comparable to each other, we can assume that the remaining part of the received total signal is a white one. This latter situation corresponds to a situation where the mobile station is located close to the edge of a cell, in the handover region.

It should be noted that, a white signal can be modelled as a signal that passed a single-ray channel.

Assume the received total signal is mainly from J base stations (where J=1˜3 or 4). The impulse response of the multipath channels of the base station can be denoted as

$${h}_{j} ( n ) = {\sum }_{l = 1}^{{L}_{j}} {α}_{jl} \cdot δ ( n - ( l - 1 ) ) , \\ j = 1 , … , J \qquad ( 1 )$$

where n denotes the time in terms of chips, Lⱼ is the number of rays in the j:th multipath and αⱼₗ is the complex ray weight of the l:th ray of the j:th multipath channel.

We assume a unit power gain,

$${gh}_{j} = {\sum }_{n}^{} {‖ {h}_{j} ( n ) ‖}^{2} = {\sum }_{l = 1}^{{L}_{j}} {‖ {α}_{jl} ‖}^{2} = 1 , \\ j = 1 , … , J \qquad ( 2 )$$

If the power gain of the actual multipath channel is not a unit one, the multipath channel is normalized so that the normalized multipath channel has a unit power gain. Only the normalized multipath channel should be used in the power estimator function block according to the present invention which will be described below. The multipath channel could be estimated by using techniques for multipath channel estimation that are well known to the person skilled in the art. Such techniques may involve de-spreading either the common or the dedicated pilot symbols on each finger of a RAKE-receiver and then average the successive quantities within a certain period of time. More information about multipath channel estimation can be found in chapter 4.4 of Viterbi, Andrew J., “CDMA: Principles of Spread Spectrum Communication,” Addison-Wesley Wireless Communications, 1995.

The remaining part of the received total signal is modelled as a white noise. For consistency we assume it has passed a single-ray channel with the impulse response
hⱼ₊₁(n)=δ(n), (3)
Thus the single-ray channel has a unit power gain:
ghⱼ₊₁=1
If x(n) represents a vector of the input signals to the multipath channels, then the output signal from each multipath channel is denoted as
yⱼ(n)=hⱼ(n)*xⱼ(n) j=1, . . . ,J+1 (4)
and its power is
Iⱼ=E[∥yⱼ(n)∥²]=E[∥xⱼ(n)μ²]=Pⱼ j=1, . . . ,j+1 (5)
where
Pⱼ=E[∥xⱼ(n)∥²], j=1, . . . ,j+1 (6)
is the transmitted power before each multipath channel.

Thus the received total signal at the receiver front end can be denoted as

$$y ( n ) = {\sum }_{j = 1}^{J + 1} {y}_{j} ( n ) = {\sum }_{j = 1}^{J + 1} ( {h}_{j} ( n ) * {x}_{j} ( n ) ) , \qquad ( 7 )$$

where xⱼ(n) is an independent and identical distribution and the power of the received total signal is

$${I}_{tot} = E [ {‖ y ( n ) ‖}^{2} ] = {\sum }_{j = 1}^{J + 1} {I}_{j} . \qquad ( 8 )$$

According to the present invention a power estimator is provided which is arranged to estimate the received powers from the J base stations separately and the power of the white noise, namely “Iⱼ”, where j=1, . . . ,J+1. I₁ is the received power from the first base station, I₂ is the received power from the second base station etc., and Iⱼ₊₁ is the received power from white noise.

At the CDMA receiver, we assume a channel estimation functionality has already estimated the impulse responses of all J multipath channels, and that hⱼ₊₁(n)=δ(n) is always known to the receiver. The power estimator according to the present invention includes a set of matched filters that are matched to the multipath channels such that the impulse responses of the filters are the conjugate of the time-reverse of the respective multipath channel's impulse response. Let rⱼ(n) denote the impulse response of filter j which is matched to channel j, then
rⱼ(n)=hⱼ*−n), j=1, . . . ,J+1 (9)
where h*(n) is the conjugate of h(n), i.e. h*(−n)=Re(h(−n))−j·Im(h(−n)).

The matched filters are modelled as tapped delay lines. If the impulse response of a multipath channel is

$$h ( n ) = {\sum }_{l = 1}^{L} {α}_{l} \cdot δ ( n - {τ}_{l} ) \qquad ( 10 )$$

where L is the number of rays in the multipath channel, αₗ is the complex ray weight of the l:th ray, and τₗ is the ray time delay of the l:th ray, then the corresponding matched filter is

$$r ( n ) = {\sum }_{l = 1}^{L} conj ( {α}_{l} ) \cdot δ ( n + {τ}_{l} ) \qquad ( 11 )$$

The output signal from each matched filter is denoted as

$$\begin{matrix}{ry}_{j} ( n ) = {r}_{j} ( n ) * y ( n ) \\ = {\sum }_{i = 1}^{J + 1} ( {r}_{j} ( n ) * {h}_{i} ( n ) * {x}_{i} ( n ) ) \\ = {\sum }_{i = 1}^{J + 1} ( {eh}_{ji} ( n ) * {x}_{i} ( n ) ) , j = 1 , … , J + 1\end{matrix} \\ where \\ \begin{matrix}{eh}_{ji} ( n ) = {r}_{j} ( n ) * {h}_{i} ( n ) \\ = {h}_{j}^{*} ( - n ) * {h}_{i} ( n ) , i , j = 1 , … , J + 1\end{matrix} \qquad ( 12 )$$

where the operator “*” denotes the operation of linear convolution. The power of the output signal from each matched filter is

$$\begin{matrix}{Pr}_{j} = E [ {‖ {ry}_{j} ( n ) ‖}^{2} ] \\ = {\sum }_{i = 1}^{J + 1} ( {geh}_{ji} \cdot {P}_{i} ) \\ = {\sum }_{i = 1}^{J + 1} ( {geh}_{ji} \cdot {I}_{i} ) , j = 1 , … , J + 1\end{matrix} \\ where {geh}_{ji} = {\sum }_{n}^{} {‖ {eh}_{ji} ( n ) ‖}^{2} = {geh}_{ij} , i , j = 1 , … J + 1 \qquad ( 13 )$$

Especially
Pr_{J+1}=E[∥ry_{J+1}(n)∥²]=E[∥y(n)∥²]=Iₜₒₜ (14)
since the filter that is matched to the model of the normalized single ray channel in corresponds to a full pass line, i.e. the output of the filter is exactly the same as the input

In (13) gehⱼᵢ is the power gain of the cascaded filter of the i:th multipath channel and the j:th matched filter.

The set of linear equations in (13) can be expressed in the matrix form as
Pr=geh·I (15)
where Pr is a (J+1)-by-1 column vector with elements Prⱼ, and I is a (J+1)-by-1 column vector with elements Iⱼ, and geh is a (J+1)-by-(J+1) matrix with elements gehⱼᵢ. The solution of equation (15) is
I=geh⁻¹·Pr (16)

Thus, the power estimator according to the present invention is required to be able to invert the matrix geh in order to derive the solution for I, which is composed of the received powers from the J base stations and the power of the white noise. Therefore the power estimator according to the present invention includes a matrix division operation block.

As long as the estimations of the power Prⱼ and the channel impulse response hⱼ(n) are accurate enough, the received power Iⱼ from base station j can be estimated with fairly good accuracy.

It should be noted that in order for the power estimator of the present invention to be able to differentiate the received powers from the different base stations using the matched filters, the signals from the different base stations cannot have the same power spectrum. In other words equation (16) requires that
hⱼ(n)≠hᵢ(n) or hᵢ*(−n), for j≠i and j,i=1, . . . ,J+1 (17)
i.e.
∥Hⱼ(m)∥≠∥Hᵢ(m)∥, for j≠i and j,i=1, . . . ,J+1

This is the drawback of the present invention. However, if the output signals yⱼ and yᵢ of two base stations from their respective multipath channel have the same correlation feature it should, from an application point of view, be satisfactory to estimate the sum of the received powers Iⱼ+Iᵢ from the two bases stations and the power estimator according to the present invention is able to estimate this sum.

FIG. 2 shows a schematic block diagram of a power estimator 1 according to the present invention located in a CDMA receiver 2. The CDMA receiver receives a total signal y (with the power Iₜₒₜ) which is composed of received signal components y₁ (with the power I₁), . . . , yⱼ (with the power Iⱼ), . . . , y_{J} (with the power Iⱼ) from J base stations and a noise signal component yⱼ₊₁ (with the power I_{J+1}) which is assumed to be white noise. The received signal components from the J base stations originates from transmitted signals x₁ (with the power P₁), . . . ,xⱼ (with the power Pⱼ), . . . , x_{J} (with the power P_{J}) that have passed J multipath channels 3. These multipath channels 3 are modelled to have the impulse responses h₁(n), . . . hⱼ(n), . . . hⱼ(n). Since the noise signal component is assumed to be a white one this signal component can be modelled to as a transmitted signal x_{J+1}(n) which has passed a single-ray channel 4 with impulse response hⱼ₊₁(n)=δ(n). The power estimator according to the present invention includes a channel estimator block 5 which is arranged to estimate the impulse responses of the J multipath channels using an algorithm that is well known to the person skilled in the art. The power estimator 1 further includes a set of matched filters 6 which are matched to the J multipath channels 3 and the single-ray channel 4. The set of matched filters are needed to be able to differentiate the power from the different signal components of the total received signal that originates from the different base stations and the white noise. The powers of the output signals from the matched filters are used in a matrix division operation block 7 of the power estimator 1 to derive the received powers from the J different base stations and the power of the white noise.

As mentioned above, there are several known techniques for performing channel estimation in a CDMA system. The channel estimator 5 used in the power estimator according to the invention may thus be implemented using hardware implementations according to prior art, such as channel estimator hardware applied in IS-95 systems. The quality of the channel estimation is essential for the performance of the channel estimator according to the present invention. CDMA mobile stations that support soft hand-over are required to provide multipath channel estimations for all base stations within the active set. Thus the present invention may make use of the existing channel estimation feature of such mobile stations and export the estimated channel impulse responses to the power estimator according to the present invention. Thus a dedicated channel estimator is not required for the power estimator of the present invention.

The set of matched filters 6 may be realised as a special RAKE receiver with a de-spreading sequence of “1”. Thus a standard CDMA block can be used to implement the set of matched filters of the power estimator according to the present invention.

The implementation of the matrix division operation block 7 may require new hardware and/or software, but it is also possible to implement this block using standard digital signal processor algorithms of an ordinary CDMA receiver so that no new hardware is required and only small modifications of existing software are needed.

From the above discussion it is clear that, when implementing the present invention in a CDMA receiver according to prior art, the only added hardware may be the set of matched filters. From this description, it will be apparent to the person skilled in the art how the present invention may be implemented using known hardware and software means with appropriate modifications.

Another aspect of the present invention is the number of base stations from which the power estimator estimates the received power, i.e. J. The mobile station is arranged to continuously search for base stations with good enough signal quality for handover purposes. J is the number of detectable base stations seen by the mobile station. J varies and the present invention is not limited to any specific value of J. Typically the received total signal at the mobile station is mainly from 1 to 4 base stations, so that a typical range of J is from 1 to 4. The suitable value of J depends on the mobile station's position within a cell. For instance, at the cell centre J is usually equal to 1 and at the cell edge (during soft handover) J is typically within the range of 2 to 4. A threshold can be defined for providing power estimation from a particular base station in the power estimator. The threshold can for instance be set to 3 dB so that the received power from a particular base station is estimated only if the Common Pilot Channel (CPICH) Received Signal Code Power (RSCP) of the base station is higher than the highest CPICH RSCP from any base station subtracted by the threshold of 3 dB. However, there are other ways of determining J and the present invention is not limited to any specific method for determining J.

Above we assumed that apart from the signal components from the J strong base stations the total received signal comprised a signal component of white noise. This noise component is made up of signals from weak base station, i.e. other base stations than the J strong ones, and thermal noise. If one is able to determine that the noise component is very small and can be neglected, the received powers from the J base stations can be determined without also computing the power received from white noise. In such a case the filter that is matched to the model of the normalized single-ray channel could be dispensed with.

The estimated interference power, i.e. the estimated received powers from different base stations can be applied in a number of ways in the CDMA system.

The estimated interference power can be used to calculate the geometry factor (GF),

$${GF}_{j} = \frac{{I}_{j}}{{I}_{tot} - {I}_{j}} , j = 1 , … , J \qquad ( 18 )$$

The geometry factor is the ratio between the received power from the mobile stations serving base station and the received power from all the other base stations. Usually the geometry factor measures the position of the mobile station in the network. A high value of the geometry factor means that the mobile station is very close to the serving base station or the cell centre, while a low value of the geometry factor means that the mobile station is close to the cell border. The estimated geometry factor may be used to control parameters of the mobile station, e.g., filter parameters and parameters that determine how often cell search is performed. The geometry factor may also be transmitted to the radio access network to be used for radio network diagnostic purposes.

Power control purposes the effective interference plus noise power is of interest, which can be calculated using the power estimations provided by the power estimator according to the present invention.

Suppose base station j is the serving base station and the mobile is receiving a signal from it. The effective interference plus noise power after de-spreading can be calculated as

$$\begin{matrix}Var ( {ru}_{desired} ) = \frac{1}{SF} ( E ( {‖ ry ( n ) ‖}^{2} ) - {I}_{j} \cdot {‖ eh 0 ‖}^{2} ) \\ where & ( 19 ) \\ eh ( n ) = r ( n ) * {h}_{j} ( n ) \\ and \\ eh 0 = eh 0 = {\sum }_{n}^{} ( r ( - n ) {\cdot }_{j} ( n ) ) & ( 20 )\end{matrix}$$

and hⱼ(n) is the normalized multipath impulse response for base station j′ and Iⱼ is the received power from base station j. ru_{desired} is the recovered data symbol of a desired user and SF is the spreading factor of this user. eh0 is the complex tap weight of the cascaded filter of the multipath channel and the receiver filter at the time instant of zero. The data symbol of the desired user is recovered at this tap. r(n) can be any generic chip-level filter, for example a matched filter in case of a RAKE receiver or a MMSE (Minimum Mean Square Error) equaliser in case of a G-RAKE receiver (generic RAKE receiver). The Interference Signal Code Power (ISCP) defined in 3GPP can be calculated as

$$ISCP = \frac{1}{{‖ eh 0 ‖}^{2}} \cdot E ( {‖ ry ( n ) ‖}^{2} ) - {I}_{j} \qquad ( 21 )$$

Usually the receiver filter is normalized so that
eh0=1

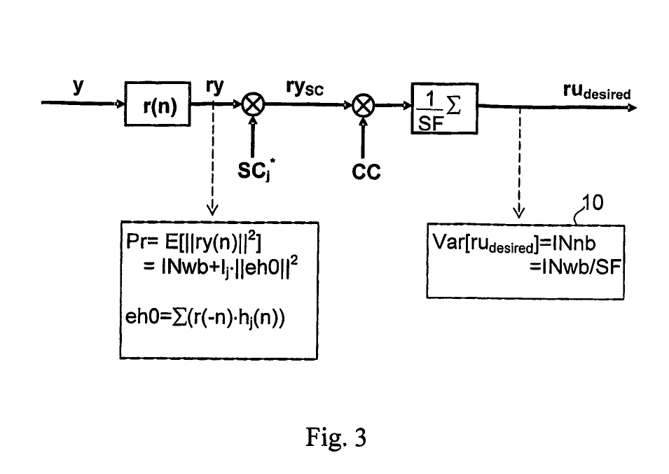

FIG. 3 illustrates how the effective interference plus noise power for a de-spreaded signal may be estimated. A received total signal, y, is fed to a receiver filter, r(n), and then de-scrambled by SCⱼ* which is the conjugate of the complex scrambling code SC. Thereafter the signal is de-spreaded by CC, which is the channelisation code allocated to the desired user, i.e the Walsh code in the IS-95 systems or the OVSF code in the WCDMA systems. Thus the data symbol of the desired user is recovered. The effective interference plus noise power could then be calculated by applying the estimated interference power from the base station according to this invention as indicated by block 10, where INnb is the effective interference plus noise power measured after the de-spreading operation, and INwb is the equivalent wide band interference plus noise power before the de-spreading operation.

The power estimates supplied by the present invention is furthermore useful when constructing a G-RAKE receiver or a MMSE equaliser. The construction of the G-RAKE receiver or the MMSE equaliser requires knowledge about the auto-correlation function of the received total signal. This function can be derived from the normalised multipath channel, hⱼ(n), and the received powers, Iⱼ as follows

$$ac ( τ ) = {\sum }_{j = 1}^{J + 1} {ac ( τ )}_{j} = {\sum }_{j = 1}^{J + 1`} ( {I}_{j} \cdot ( {h}_{J}^{*} ( - n ) * {h}_{j} ( n ) ) ) \\ and \\ τ = - ( K - 1 ) , … , ( K - 1 ) , K = max \{ {L}_{j} , j = 1 , … , J \qquad ( 22 )$$

From the above discussion it is evident that the power estimates provided by the power estimator according to the present invention may be employed in many ways in the CDMA system. Advantages of the present invention compared to methods and apparatuses for interference power estimation according to the prior art are that method and apparatus according to the invention will not require any modification of the current CDMA standards, and will not create any added signalling burden.

In the drawings and specification, there have been disclosed typical preferred embodiments of the invention and, although specific terms are employed, they are used in a generic and descriptive sense only and not for purposes of limitation, the scope of the invention being set forth in the following claims.

1. An apparatus for power estimation, which apparatus is arranged to estimate the powers of a set of signals received in a receiver, which set of signals are signals from a set of base stations that each has passed a multipath channel of an air interface, characterised in that the apparatus comprises:
a set of filters each for filtering a received total signal, wherein each filter of the set of filters is matched to a normalized model of one of the multipath channels of a respective one of the base stations; and
calculation means for calculating an estimate of the received power from each base station in the set of base stations based on the output signals from the set of filters.

2. The apparatus of claim 1, characterised in that the calculation means further are arranged to calculate the estimate of the received power from each base station in the set of base stations and the received power from white noise based on the output signals from the set of filters and from the received total signal.

3. The apparatus of claim 2, characterised in that the calculation means are arranged to calculate the estimate of the received power from each base station in the set of base stations and the received power from white noise by solving the system of equations given by
I=geh⁻¹·Pr,
where I is a column vector with the estimates of the received power from each base station in the set of base stations and the received power from white noise as elements, geh⁻¹ is the inverse of a matrix with the power gains of a respective one of the normalized multipath channel models cascaded with a respective matched filter of the set of filters as elements, and Pr is a vector with the power of the output signals from the set of filters and the power of the total received signal as elements.

4. The apparatus of claim 1, characterised in that each of the filters of the set of filters are matched to a respective multipath channel such that the impulse response of the filter is the conjugate of the time-reverse of an estimate of the impulse response of the normalized multipath channel.

5. The apparatus of claim 1, characterised in that the apparatus further includes a channel estimator for estimating the impulse responses of the multipath channels.

6. The apparatus of claim 1, characterised in that said filters are implemented by a RAKE receiver with a de-spreading sequence equal to 1.

7. The apparatus of claim 1, characterised in that the apparatus is arranged to estimate the received signal power from base stations from which the received signal code power on the Common Pilot Channel is higher than a predetermined threshold.

8. The apparatus of claim 1, characterised in that the apparatus is part of a CDMA receiver of a mobile station.

9. The apparatus of claim 1, characterised in that the apparatus further includes means for calculating the geometry factor based on estimates of the received powers from the base stations.

10. The apparatus of claim 1, characterised in that the apparatus further includes means for calculating the effective interference plus noise power based on estimates of the received powers from the base stations.

11. The apparatus of claim 1, characterised in that the apparatus further includes means for calculating the auto-correlation function of the received total signal based on estimates of the received powers from the base stations.

12. A method for power estimation which involves estimating the powers of a set of signals received in a receiver, which set of signals are signals from a set of base stations that each has passed a multipath channel of an air interface, characterised by the steps of:
filtering a received total signal through a set of parallel filters, wherein each filter of the set of filters is matched to a normalized model one of the multipath channels of a respective one of the base stations; and
calculating an estimate of the received power from each base station in the set of base stations based on the output signals from the set of filters.

13. The method of claim 12, characterised in that said calculation step includes calculating the estimate of the received power from each base station in the set of base stations and the received power from white noise based on the output signals from the set of filters and from the received total signal.

14. The method of claim 13, characterised in that the estimate of the received power from each base station in the set of base stations and the received power from white noise is calculated by solving the system of equations given by
I=geh⁻¹·Pr,
where I is a column vector with the estimates of the received power from each base station in the set of base stations and the received power from white noise as elements, geh⁻¹ is the inverse of a matrix with the power gains of a respective one of the normalized multipath channel models cascaded with a respective matched filter of the set of filters as elements, and Pr is a vector with the power of the output signals from the set of filters and the power of the total received signal as elements.

15. The method of claim 12, characterised in that each of the filters of the set of filters are matched to a respective multipath channel such that the impulse response of the filter is the conjugate of the time-reverse of an estimate of the impulse response of the normalized multipath channel.

16. The method of claim 12, characterised in that the method further includes the step of estimating the impulse responses of the multipath channels and the step of determining the characteristics of the filters based on the estimated impulse responses of the multipath channels.

17. The method of claim 12, characterised in that the method further includes the step of determining the base stations from which the received power is estimated, wherein it is determined to estimate the received power from a base station if the received signal code power on the Common Pilot Channel of the base station is higher than a predetermined threshold.

18. The method of claim 12, characterised in that said receiver is a CDMA receiver of a mobile station.

19. The method of claim 12, characterised in that the method further includes the step of calculating the geometry factor based on the estimates of the received powers from the base stations.

20. The method of claim 19, characterised in that the method further includes the step controlling terminal parameters of a mobile station based on the calculated geometry factor.

21. The method of claim 19, characterised in that the method further includes the step of deriving radio network diagnostics based on the calculated geometry factor.

22. The method of claim 12, characterised in that the method further includes the step of calculating the effective interference plus noise power based on the estimates of the received powers from the base stations.

23. The method of claim 12, characterised in that the method further includes the step of calculating the auto-correlation function of the received total signal based on the estimates of the received powers from the base stations.
